(19) United States
(12) Patent Application Publication
(10) Pub. No.: US 2015/0002513 A1
(43) Pub. Date: Jan. 1, 2015

(54) User Modeling Using FFT-Based Time-Series Processing

(71) Applicant: Venor, Inc., Mountain View, CA (US)

(72) Inventor: Rudi Cilibrasi, Mountain View, CA (US)

(73) Assignee: Venor, Inc., Mountain View, CA (US)

(21) Appl. No.: 14/208,971

(22) Filed: Mar. 13, 2014

Related U.S. Application Data
(60) Provisional application No. 61/780,606, filed on Mar. 13, 2013.

(51) Int. Cl. G06T 11/20; G06T 11/60

(52) U.S. Cl. CPC G06T 11/206; G06T 11/60
USPC 345/440

(57) ABSTRACT

A method to combine and visualize FFT power spectrum data that utilizes more sensor information and provides a richer output display is provided. In some embodiments, all sensors are analyzed using FFT simultaneously in the frequency ranges of 0.01 Hz to 100 Hz. Gaussian Mixture Models are then used to describe the resultant power spectrum for each sensor. The power spectra from all sensors are then combined at each moment in time. The resulting power spectrum represents the most noticeable frequencies from all sensors at any time without regard to which sensor is picking up the power within a given frequency band. Some embodiments accumulate and combine these sensor-combination power spectra over long time periods and average with several bins.

### CROSS-REFERENCE TO RELATED APPLICATION

This application claims priority to provisional application No. 61/780,606 filed Mar. 13, 2013, the contents of which are incorporated herein by reference and in their entirety.

### BACKGROUND

We begin by introducing two important concepts. The first describes the recent and historical deployment of sensor arrays on mobile devices. The second refreshes our memory of the ubiquitous spectrographic display common in many consumer devices.

We assume the reader is familiar already with the Fast Fourier Transform (or FFT), and do not explain the widely celebrated algorithm in depth in this document. Suffice to say that FFT converts between the time and frequency domains, allowing efficient analysis of any incoming time series for periodic patterns.

Mobile phones have enabled entire systems of calibrated, cost-effective, and power-efficient sensors to be deployed near human beings throughout much of the world. At the same time, this massive influx of information has led to new challenges in data mining. Even though mobile phones have enabled ubiquitous measurement, there are relatively few applications due to limited software intelligence.

### SUMMARY

Various embodiments include a generic method using software to enable average users to utilize a majority of the sensors on their phone or other mobile device or an arbitrary user-associated sensor device for data mining their own personal behaviors or those of other people using intuitive displays of FFT information. Some embodiments apply to all time-series data whose elements have a scalar interpretation and whose subject is a human user. This generality may enable the method to work equally well on a wide range of sensors without regards to specifics as long as they can be made to generate a conventional numeric signal equipped with a timestamp of some sort.

### BRIEF DESCRIPTION OF THE DRAWINGS

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted, based on this disclosure, in view of the common knowledge within this field.

FIG. 1 is a greyscale version of a colorful display of spectrogram history over many hour samples. Colors are labeled by number as follows: red (1), umber (2), orange (3), yellow (4) light green (5), middle green (6), green (7), blue green (8), aqua (9), blue (10), dark blue (11), purple (12), pink (13). There are two peaks shown in the left side whose central colors are indicated by the red-labeled and blue-labeled concentric filled circles at the 8 am and 0.1 Hz grid-square. The visible area ratios of the circles correspond to the power ratio of the peaks. The circle at this square represents the frequency band 0.1 Hz-0.3 Hz. The rainbow spectrum is used identically for each frequency band to add an easy-to-remember visual cue that can also easily display historical information. One simple way is to use alpha-transparency blending to fade out historical spectrographic data over time.

### DETAILED DESCRIPTION

Fingerprints entered by the current user are displayed differently: Long Tapping on them brings up an option to delete them

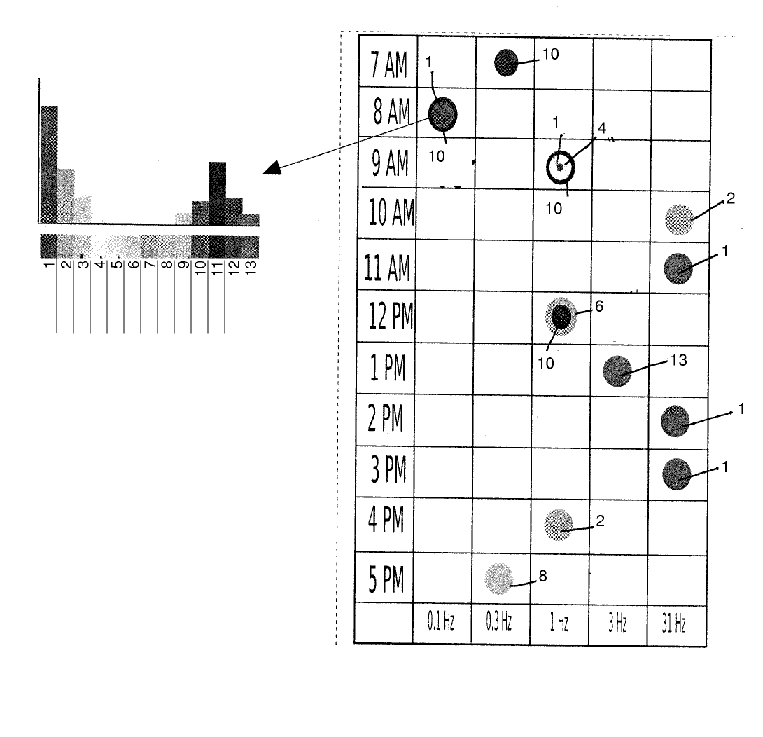

The mathematical assumptions may be similar in the typical FFT display that has been well-known for over twenty years. An example is shown in FIG. 1. The basic spectrographic image has a familiar shape that many people recognize as a graphic equalizer in modem audio equipment at the mass-consumer level. We briefly describe at least one embodiment here and continue in more depth in later sections.

At least one novel embodiment is pictured next to the classical spectrograph for comparison. In this example, each grid square contains a summary of the peaks that have been detected in the spectrographic power historically in that time (8 am) and frequency-band (0.1 Hz-0.3 Hz). False rainbow coloring that is familiar is used consistently for all bands so that each color in each vertical column has a common frequency according to hue. The area that is shown in each color is displayed in a way that shows area proportional to power. The circles may be drawn in either sorted order (this may be a user configuration option), for instance with the largest peak in the center and the rest in descending order going outward.

Although few people would recognize the technical term Fast Fourier Transform or FFT, most people in technically developed and affluent countries would recognize the typical colorful display that is shown on many stereo graphic equalizers and be able to interpret the changing bar graph that corresponds to musical frequencies. Conventionally, higher frequencies are drawn on the right and lower on the left and amplitude is represented by the height of each bar. This particular method of data display is so powerfully intuitive that it has become almost second-nature to wide segments of the population. Each grid square in our invention can drill down into a full classical FFT spectrograph display to connect with users' intuitive understanding. By careful color coordination we provide the user with an intuitive and easy-to-grasp way to understand and assign meaning to the history of their own or others' spectrographs.

We have developed at least one new method to combine and visualize FFT power spectrum data that utilizes more sensor information and provides a richer output display that is more informative over longer time periods than traditional graphic equalizer displays. A weakness of the graphic equalizer is that it is normally only showing a window of less than ten seconds of sampling with only one sensor, typically equivalent to an audio/electronic sensor for the music source. We propose, in various embodiments, generalizing the sensor inputs to be all conveniently available sensors. In some embodiments, we propose analyzing all sensors using FFT simultaneously in the frequency ranges of 0.01 Hz to 100 Hz. Then we can use simple Gaussian Mixture Models to describe the resultant power spectrum for each sensor. We can do this computation for each sensor individually in a small number of dimensions or in higher-dimensional Cartesian product of sensor data as vectors, for example. We can combine these power spectra from all sensors at each moment in time. This resulting power spectrum represents the most noticeable frequencies from all sensors at any time without regard to which sensor is picking up the power within a given frequency band. We call this power spectrum the sensor-combination power spectrum. Some embodiments accumulate and combine these sensor-combination power spectra over long time periods and average with several bins. The bins may be labeled according to the standard human timescales of artificial calendrical periodicity: hour of the day, day of the week, day of the month, and year. Of course the user may adjust the temporal granularity in a customizable embodiment. The user's temporal selection controls one axis (time) and the other axis is frequency displayed as a matrix. Any single colored indicator in a grid square represents a specific frequency bump identified in a particular histogram bin over time. Thus the system would be able to detect a pattern like at 7 am each day I exercise at 150 strides per minute and would show this information with a colored indicator at the grid square marked with 7:00 am and 150 BPM. The user would be expected to periodically review the FFT histogram bins that the mobile phone had accumulated in the weeks before so that he could notice what sort of things his phone was picking up. Of course, there might be things showing up on his phone that the user could not immediately identify and these would also be worth investigating within the context of a particular repeated pattern as indicated by a combination of a specific FFT frequency and a specific artificial human time-bin derived from the mobile phone clock.

The intuitive display enables users to interact with the historical FFT data they generate in potentially novel ways and opens up the possibility of being able to answer the question of what sort of behaviors (such as heart beat, walking, running, cycling, dancing, exercising, etc) might be detectable without much advanced programming. By creating an extremely intuitive display to review the time-history of power spectra picked up passively by the phone over time we can enable a new level of introspective knowledge. We may similarly use the device to model the user's local environment and thereby create new opportunities for intelligent adaptation to nearly-hidden yet mathematically detectable repeating patterns. Just as we may apply light-based spectroscopy to determine the contents of stars or unknown material samples, so we may apply our various embodiments to user models that include the rich contextual information passively available in the user's local environment.

What is claimed is:

1. A computer-implemented method for displaying sensor data about the activity of a user on a display device, comprising:
obtaining sensor data, as a function of time, from a plurality of sensors on a mobile device;
for each of a plurality of time slices, converting said sensor data from each sensor to the frequency domain via the Fast Fourier Transform;
for each time slice, combining the frequency domain data from each sensor into a combined power spectrum;
displaying a grid on the display device, with one time axis and another frequency axis;
display markings on the display device, at a location corresponding to the time and frequency of a plurality of peaks above a particular threshold in the combined power spectrum.
